(19) United States
(12) Patent Application Publication
(10) Pub. No.: US 2006/0037225 A1
(43) Pub. Date: Feb. 23, 2006

(54) Inflatable seasonal display

(76) Inventor: Kuo-Jui Wei, Taipei City (TW)

Correspondence Address: PRO-TECHTOR INTERNATIONAL, 20775 Norada Court, Saratoga, CA, 95070-3018, US

(21) Appl. No.: 10/921,563

(22) Filed: Aug. 18, 2004

(51) Int. Cl. G09F 15/00

(52) U.S. Cl. 40/610

(57) ABSTRACT

An inflatable seasonal display includes a costume, an air-filled inner body, an inflating pump set, light emitting devices, lighted decorative elements, a shaking device, a deflation assisting means and a power supply device. The costume has a zipper. The air-filled inner body is installed in the costume through the zipper. The air-filled inner body has an air valve, through which the inflating pump set inflates the air-filled inner body. The lighted decorative elements are attached on the costume, which are brightened by the light emitting devices. The shaking device enables the inflatable seasonal display to swing back and forth for entertaining purpose. The deflation assisting means accelerates the deflating period of the air-filled inner body. The power supply device is electrically connected to all electronic devices and provides power.

### BACKGROUND

1. Field of Invention

The present invention relates to an inflatable seasonal display. More particularly, the present invention relates to a portable, entertaining and easily stored inflatable seasonal display.

2. Description of Related Art

In general, the inflatable seasonal display of the prior art is full of stuffs, such as cottons or foam rubbers. However, the shape of the prior art will be limited by stuff. Therefore, it is not convenient for user to store and carry and for transportation.

### SUMMARY

It is therefore an objective of the present invention to provide inflatable seasonal display so as to provide a portable, entertaining and easily stored inflatable seasonal display.

In accordance with the foregoing and other objectives of the present invention, an inflatable seasonal display includes a costume, an air-filled inner body, an inflating pump set, light emitting devices, lighted decorative elements, a shaking device, a deflation assisting means and a power supply device. The costume has a zipper. The air-filled inner body is installed in the costume through the zipper. The air-filled inner body has an air valve, through which the inflating pump set inflates the air-filled inner body. The lighted decorative elements are attached on the costume, which are brightened by the light emitting devices. The shaking device enables the inflatable seasonal display to swing back and forth for entertaining purpose. The deflation assisting means accelerates the deflating period of the air-filled inner body. The power supply device is electrically connected to all electronic devices and provides power.

Thus, the inflatable seasonal display demonstrates the following advantages

1. The air-filled inner body can be inflated or deflated so that it can be stored easily and portable.

2. It is equipped with deflation assisting means, which deflates the air-filled inner body quickly.

3. It is equipped with shaking device, which enables itself to swing back and forth. This means increases its entertaining function.

It is to be understood that both the foregoing general description and the following detailed description are by examples, and are intended to provide further explanation of the invention as claimed.

### BRIEF DESCRIPTION OF THE DRAWINGS

The accompanying drawings are included herewith to provide a further understanding of the invention, and are incorporated in and constitute a part of this specification. The drawings illustrate embodiments of the invention and, together with the description, serve to explain the principles of the invention. In the drawings,

FIGS. 1 and 1A illustrate a perspective view of an inflatable seasonal display according to one preferred embodiment of this invention;

FIG. 2 Illustrates a perspective view of an inflatable seasonal display according to another preferred embodiment of this invention;

FIG. 3A illustrates a perspective view of an inflatable seasonal display according to yet another preferred embodiment of this invention; and

FIG. 3B illustrates a perspective view of an inflatable seasonal display's appearance according to yet another preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

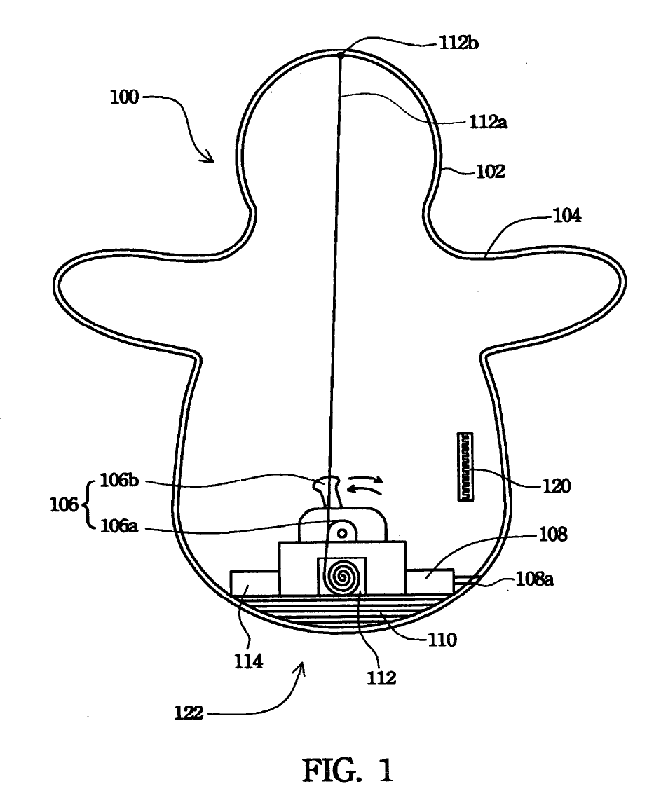

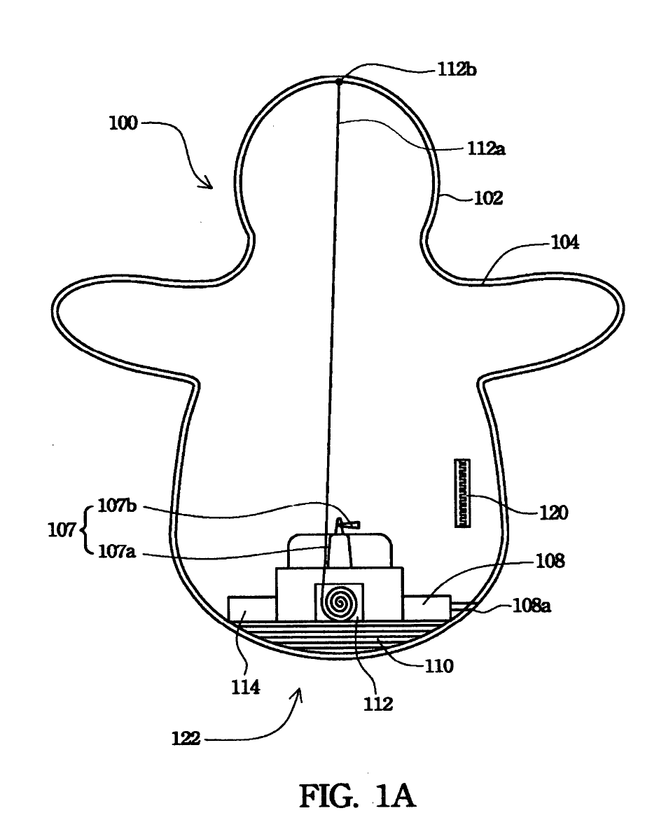

FIGS. 1 and 1A illustrate a perspective view of an inflatable seasonal display according to one preferred embodiment of this invention. The inflatable seasonal display 100 includes a costume 102 and an air-filled inner body 104. The costume 102 is made of cloth or plastic materials and has a zipper 120 placed thereon and an incomplete-sphere bottom 122. The air-filed inner body 104 is made of plastic materials and installed in the costume 102 through the zipper 120. The air-filled inner body, installed in the costume 102, has an air valve 108a thereon to inflate or deflate the air-filled inner body 104. A base 110 mounted inside at the bottom of the air-filled inner body 104 should be heavy enough to make the inflatable seasonal display 100 stand upright with its incomplete-sphere bottom 122. An inflating pump set 108 including a pressure sensor (not illustrated in FIG. 1) is mounted on the top of the base 110 to inflate the air-filled inner body 104 via the air valve 108a. A deflation assisting means 112, mounted on the base 110, includes a thread 112a attached to a top point 112b of the air-filled inner body 104 to pull it down when the air-filled inner body 104 is being deflated. A spring or a servomotor installed inside the deflation assisting means 112 can drive the thread 112a down. On top of the deflation assisting means 112, a shaking device 106 is employed to enable the inflatable seasonal display 100 to swing back and forth. The shaking device 106 includes a motor 106a and a shaking load 106b swinging back and froth. The shaking load 106b, driven by the motor 106a, should be heavy enough to enable the inflatable seasonal display 100 to swing back and forth. In FIG. 1A, the shaking device 106 can be replaced by another shaking device 107, including a motor 107a and a rotating load 107b. The rotating load 107b is an eccentric load, which makes the inflatable seasonal display 100 to swing back and forth when it rotates. The rotating load 107b, driven by the motor 107a, should be heavy enough to enable the inflatable seasonal display 100 to swing back and forth. A power supply (such as a battery) 114, mounted on top of the base 110, is electrically connected to the shaking device 106, the deflation assisting means 112 and the inflating pump set 108.

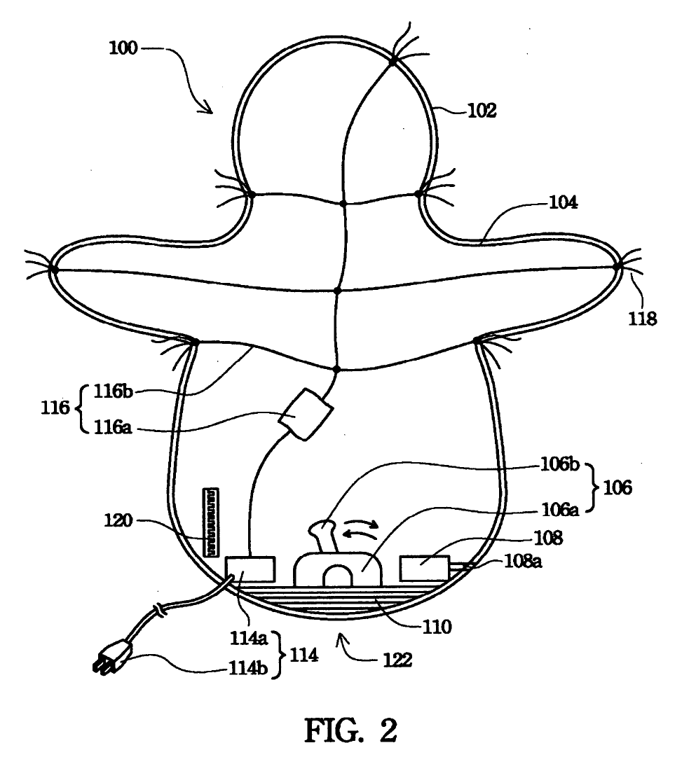

FIG. 2 illustrates a perspective view of an inflatable seasonal display according to another preferred embodiment of this invention. The inflatable seasonal display 100 includes a costume 102 and an air-filled inner body 104. The costume 102 is made of cloth or plastic materials and has a zipper 120 placed thereon and an incomplete-sphere bottom 122. The air-filled inner body 104 is made of plastic materials and installed in the costume 102 through the zipper 120. The air-filled inner body, installed in the costume 102, has an air valve 108a thereon to inflate or deflate the air-filled inner body 104. A base 110 mounted inside at the bottom of the air-filled inner body 104 should be heavy enough to make the inflatable seasonal display 100 stand upright with its incomplete-sphere bottom 122. An inflating pump set 108 including a pressure sensor (not illustrated in FIG. 1) is mounted on the top of the base 110 to inflate the air-filled inner body 104 via the air valve 108a. On top of the base 110, a shaking device 106 is employed to enable the inflatable seasonal display 100 to swing back and forth. The shaking device 106 includes a motor 106a and a shaking load 106b swinging back and froth. The shaking load 106b, driven by the motor 106a, should be heavy enough to enable the inflatable seasonal display 100 to swing back and forth. Lighted decorative elements 118 are attached on the costume 102 and connected to a light-emitting device 116. The light-emitting device 116 includes a light source 116a (such as a light bulb or a LED lamp) and fiber optical bunches 116b connected to the light source 116a. A power supply 114, mounted on top of the base 110, is electrically connected to the shaking device 106, the light-emitting device 116 and the inflating pump set 108. The power supply 114 includes a wire reel box 114a installed therein, and the wire reel box 114a has one side connected to a plug 114b.

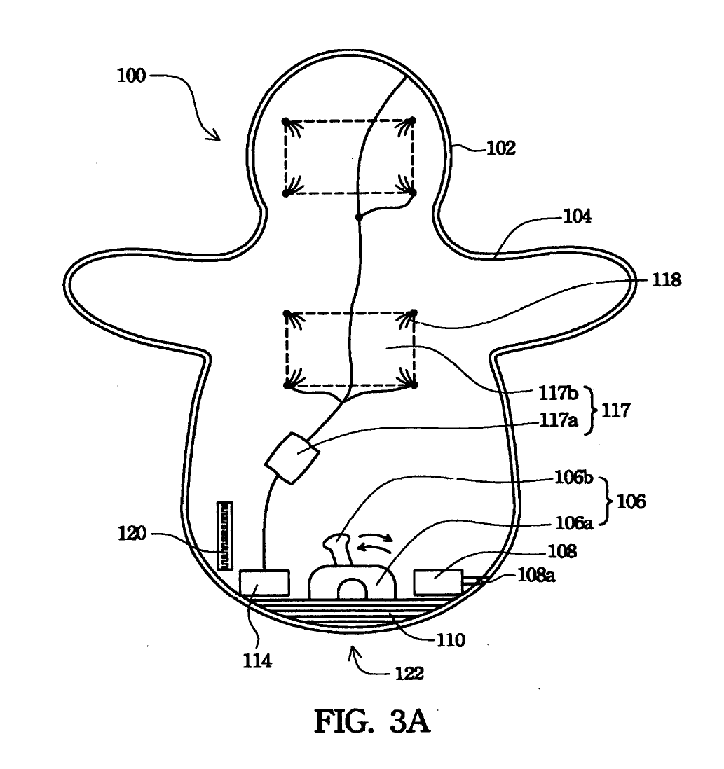

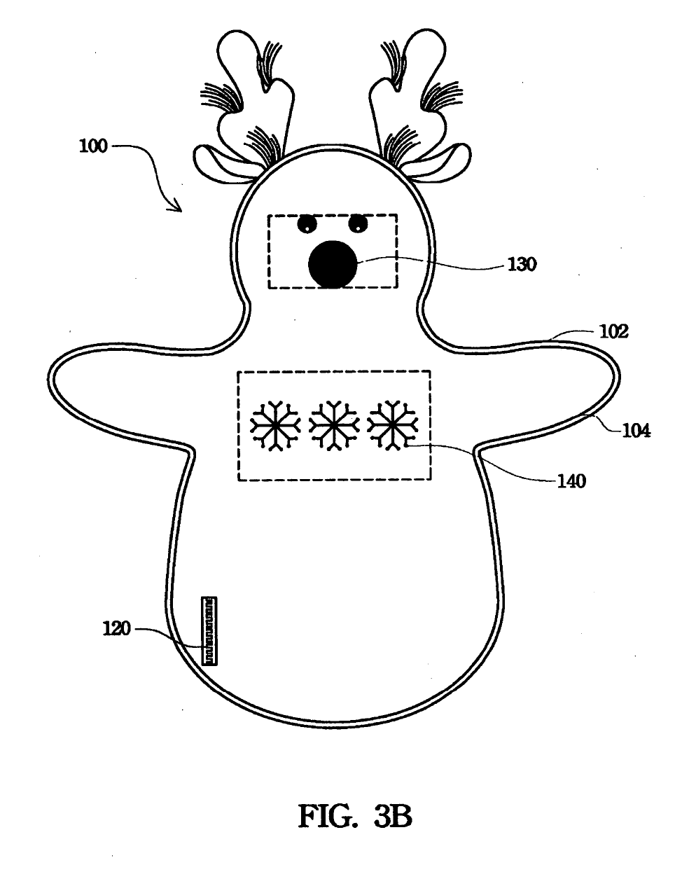

FIG. 3A illustrates a perspective view of an inflatable seasonal display according to yet another preferred embodiment of this invention. The inflatable seasonal display 100 includes a costume 102 and an air-filled inner body 104. The costume 102 is made of cloth or plastic materials and has a zipper 120 placed thereon and an incomplete-sphere bottom 122. The air-filled inner body 104 is made of plastic materials and installed in the costume 102 through the zipper 120. The air-filled inner body, installed in the costume 102, has an air valve 108a thereon to inflate or deflate the air-filled inner body 104. A base 110 mounted inside at the bottom of the air-filled inner body 104 should be heavy enough to make the inflatable seasonal display 100 stand upright with its incomplete-sphere bottom 122. An inflating pump set 108 including a pressure sensor (not illustrated in FIG. 1) is mounted on the top of the base 110 to inflate the air-filled inner body 104 via the air valve 108a. On top of the base 110, a shaking device 106 is employed to enable the inflatable seasonal display 100 to swing back and forth. The shaking device 106 includes a motor 106a and a shaking load 106b swinging back and froth. The shaking load 106b, driven by the motor 106a, should be heavy enough to enable the inflatable seasonal display 100 to swing back and forth. Lighted decorative elements 118 are attached on the costume 102 and connected to a light-emitting device 117. The light-emitting device 117 includes a light source 117a (such as a light bulb or a LED lamp) and light-guiding plate 117b connected to the light source 117a. A power supply (such as a battery) 114, mounted on top of the base 110, is electrically connected to the shaking device 106, the light-emitting device 117 and the inflating pump set 108. FIG. 3B illustrates a perspective view of an inflatable seasonal display's appearance according to yet another preferred embodiment of this invention. The light decorative elements 130 and/or 140 are brightened by the light-emitting device 117 illustrated in FIG. 3A.

According to the preferred embodiments, the inflatable seasonal display demonstrates the following advantages:

1. The air-filled inner body can be inflated or deflated so that it can be stored easily and portable.

2. It is equipped with deflation assisting means, which deflates the air-filled inner body quickly.

3. It is equipped with shaking device, which enables itself to swing back and forth. This means increases its entertaining function.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. An inflatable seasonal display comprising:
a costume, having a zipper placed thereon and an incomplete-sphere bottom;
an air-filled inner body, installed in the costume, having an air valve thereon to inflate or deflate said air-filled inner body;
a base mounted inside at the bottom of said air-filled inner body to make the inflatable seasonal display stand upright;
means for shaking the inflatable seasonal display to swing back and forth, installed in said air-filled inner body;
a power supply installed in sad air-filled inner body and electrically connected to said means for shaking the inflatable seasonal display to swing back and forth; and
means for assisting said an air-filled inner body to deflate, installed inside at the bottom side of said air-filled inner body.

2. The inflatable seasonal display of claim 1, wherein said costume is made of cloth or plastic materials.

3. The inflatable seasonal display of claim 1, wherein said air-filled inner body is made of plastic materials.

4. The inflatable seasonal display of claim 1, wherein said power supply includes a wire reel box installed therein, and said wire reel box has one side connected to a plug.

5. The inflatable seasonal display of claim 1, wherein said power supply is a battery.

6. The inflatable seasonal display of claim 1, further comprising an inflating pump set mounted inside at the bottom side of said air-filled inner body to inflate said air-filled inner body via said air valve.

7. The inflatable seasonal display of claim 1, wherein said means for assisting said an air-filled inner body deflated, includes a thread attached to the top point inside said air-filled inner body to pull it down when said air-filled inner is body is being deflated.

8. The inflatable seasonal display of claim 1, wherein said base's weight is heavy enough to make the inflatable seasonal display stand upright with said incomplete-sphere bottom.

9. An inflatable seasonal display comprising:
a costume, having a zipper placed thereon and a incomplete-sphere bottom;
an air-filled inner body, installed in the costume, having an air valve thereon to inflate or deflate said air-filled inner body;
a base mounted inside at the bottom of said air-filled inner body to make the inflatable seasonal display stand upright;
lighted decorative elements attached on said costume;
at least one light-emitting device installed in said air-filled inner body for mating with said lighted decorative elements;
means for shaking the inflatable seasonal display to swing back and forth, installed in said air-filled inner body; and
a power supply installed in sad air-filled inner body and electrically connected to said light-emitting device and said means for shaking the inflatable seasonal display to swing back and forth.

10. The inflatable seasonal display of claim 9, wherein said costume is made of cloth or plastic materials.

11. The inflatable seasonal display of claim 9, wherein said air-filled inner body is made of plastic materials.

12. The inflatable seasonal display of claim 9, wherein said light-emitting device has a light source, and fiber optical bunches or a light-guiding plate connected to said light source.

13. The inflatable seasonal display of claim 12, wherein said light source is a light bulb or a LED lamp.

14. The inflatable seasonal display of claim 9, wherein said power supply includes a wire reel box installed therein, and said wire reel box has one side connected to a plug.

15. The inflatable seasonal display of claim 9, wherein said power supply is a battery.

16. The inflatable seasonal display of claim 9, further comprising an inflating pump set, mounted inside at the bottom side of said air-filled inner body to inflate said air-filled inner body via said air valve.

17. The inflatable seasonal display of claim 9, wherein said base's weight is heavy enough to make the inflatable seasonal display stand upright with said incomplete-sphere bottom.

18. An inflatable seasonal display comprising:
a costume, having a zipper placed thereon and an incomplete-sphere bottom;
an air-filled inner body, installed in the costume, having an air valve thereon to inflate or deflate said air-filled inner body;
a base mounted inside at the bottom of said air-filled inner body to make the inflatable seasonal display stand upright;
lighted decorative elements attached on said costume;
at least one light-emitting device installed in said air-filled inner body for mating with said lighted decorative elements;
means for shaking the inflatable seasonal display to swing back and forth, installed in said air-filled inner body,
a power supply installed in sad air-filled inner body and electrically connected to said light-emitting device and said means for shaking the inflatable seasonal display to swing back and forth; and
means for assisting said air-filled inner body to deflate, installed inside at the bottom side of said air-filled inner body.

19. The inflatable seasonal display of claim 18, wherein said means for shaking the inflatable seasonal display to swing back and forth, comprises a motor and a shaking load connected to said motor.

20. The inflatable seasonal display of claim 18, wherein said means for shaking the inflatable seasonal display to swing back and forth, comprises a motor and a rotating load connected to said motor.
